(19) United States
(12) Patent Application Publication
(10) Pub. No.: US 2016/0113370 A1
(43) Pub. Date: Apr. 28, 2016

(54) Multi-Purpose Cooler

(71) Applicant: David N. Arel, JR., East Boothbay, ME (US)

(72) Inventor: David N. Arel, JR., East Boothbay, ME (US)

(21) Appl. No.: 14/522,089

(22) Filed: Oct. 23, 2014

(51) Int. Cl. A45C 11/20; A45C 13/02; B65D 25/20; A47J 47/00; B65D 81/38; A45C 13/00; A45C 13/26

(52) U.S. Cl. CPC A45C 11/20; A45C 13/005; A45C 13/02; A45C 13/26; A47J 47/005; B65D 81/3813; B65D 25/20

(57) ABSTRACT

A multi-purpose cooler includes a substantially hollow container having a wall structure that defines an interior area and an open top that provides access to the interior area. A lid is pivotally mounted to an upper edge of the wall structure and movable between a closed configuration covering the open top and an open configuration displaced from the open top. The lid includes a top portion and a bottom portion opposite the top portion, the top portion defining a recessed compartment having a bottom surface and a shelf situated about a peripheral edge of the bottom surface and extending upwardly therefrom so as to define an open space. A cutting board is removably situated atop the shelf, the cutting board being configured to prevent access to the compartment when positioned on the shelf and to allow access to the compartment when removed from the shelf.

### BACKGROUND OF THE INVENTION

This invention relates generally to insulated coolers and, more particularly, to a multi-purpose insulated cooler having a cutting board that selectively covers a lid compartment.

A cooler or ice chest is an item that frequently accompanies a fisherman on a fishing trip, such as to store food, beverages, bait, or fish having been caught. In addition, a fisherman often carries other accessories such as multiple fishing rods, tools, and even a cutting board for use in cutting up caught fish to then be stored in the cooler. Carrying all of these items is inconvenient and can significantly dampen the enjoyment of a fishing experience.

Various devices have been proposed for carrying multiple accessories related to fishing. Although assumably effective for their intended purposes, the existing devices and proposals do not provide a cooler that includes an insulated hollow interior that maintains a temperature while also including a cutting board removably coupled to a pivotal lid of the cooler and that covers a lid compartment configured to store utensils or other tools.

Therefore, it would be desirable to have a multi-purpose cooler that includes an insulated hollow interior area for storing food and beverage items in a temperature-maintained environment and that includes a cutting board coupled to the cooler's pivotal lid. Further, it would be desirable to have a multi-purpose cooler in which the lid also includes a compartment configured to store selected articles and that is selectively covered by the cutting board. In addition, it would be desirable to have a multi-purpose cooler having a plurality of rod holders and a tool holder situated on an exterior surface of the cooler.

### SUMMARY OF THE INVENTION

A multi-purpose cooler according to the present invention includes a substantially hollow container having a wall structure that defines an interior area and an open top that provides access to the interior area. A lid is pivotally mounted to an upper edge of the wall structure and movable between a closed configuration covering the open top and an open configuration displaced from the open top. The lid includes a top portion and a bottom portion opposite the top portion, the top portion defining a recessed compartment having a bottom surface and a shelf situated about a peripheral edge of the bottom surface and extending upwardly therefrom so as to define an open space. A cutting board is removably situated atop the shelf, the cutting board being configured to prevent access to the compartment when positioned on the shelf and to allow access to the compartment when removed from the shelf.

Therefore, a general object of this invention is to provide a multi-purpose cooler having a cutting board removably mounted to a pivotal lid of the cooler.

Another object of this invention is to provide a multi-purpose cooler, as aforesaid, in which the pivotal lid defines a compartment that is accessible when the cutting board is removed.

Still another object of this invention is to provide a multi-purpose cooler, as aforesaid, having a plurality of rod holders removably coupled to an exterior surface of the cooler, each rod holder configured to receive a handle of a fishing rod handle.

Yet another object of this invention is to provide a multi-purpose cooler, as aforesaid, having at least one tool holder removably coupled to an exterior surface of the cooler.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a multi-purpose cooler according to a preferred embodiment of the present invention, the cooler shown with a lid in a closed configuration;

FIG. 2 is an exploded view of the multi-purpose cooler as in FIG. 1;

FIG. 3 is another perspective view of the multi-purpose cooler illustrated with the lid removed for clarity of illustration;

FIG. 4a is a top view of the multi-purpose cooler as in FIG. 3;

FIG. 4b is a sectional view taken along line 4b-4b of FIG. 4a;

FIG. 5 is a perspective view of a multi-purpose cooler according to an alternative embodiment of the present invention, illustrated in a closed configuration;

FIG. 6 is another perspective view of the multi-purpose cooler as in FIG. 5; and

FIG. 7 is a perspective view of the multi-purpose cooler as in FIG. 5 with the cutting board exploded.

### DESCRIPTION OF THE PREFERRED EMBODIMENT

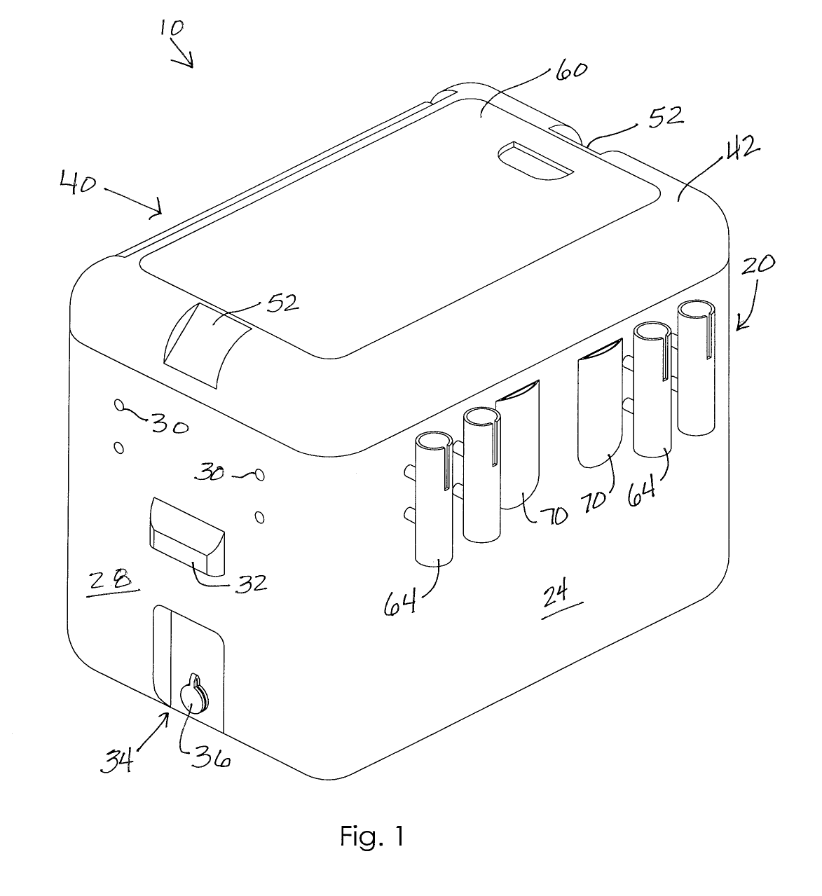

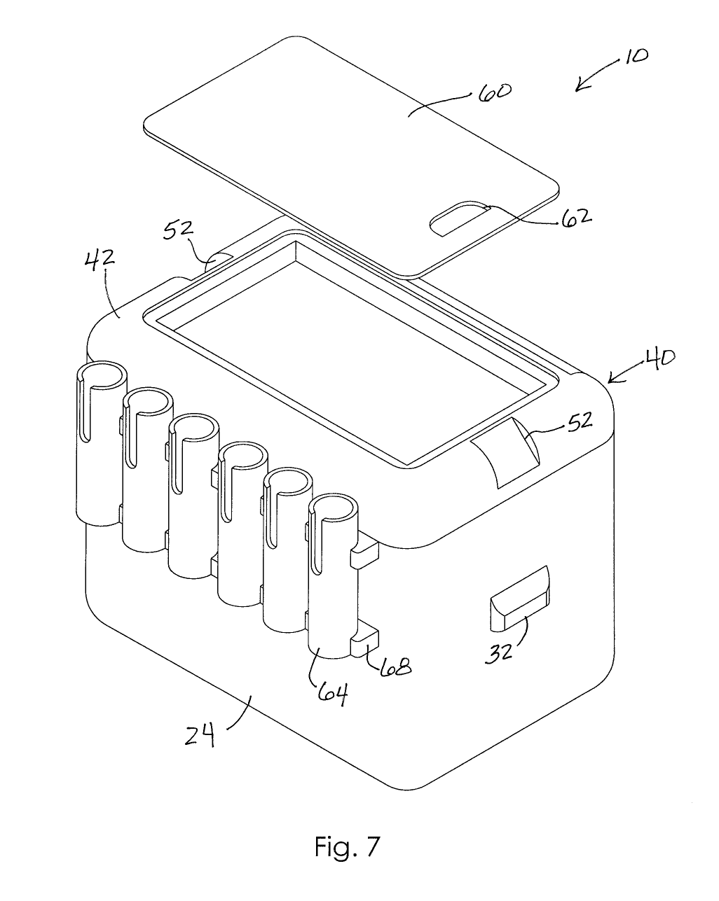

A multi-purpose cooler according to a preferred embodiment of the present invention will now be described with reference to FIGS. 1 to 7 of the accompanying drawings. The multi-purpose cooler 10 includes a hollow container 20, a lid 40, a cutting board 60, and a plurality of rod holders 64.

The multi-purpose cooler 10 includes a container 20 having a wall structure that defines a generally hollow interior area. More particularly, the container 20 includes a bottom wall 22 and opposed front 24 and back walls extending upwardly from the bottom wall 22. Opposed side walls 28 also extend upwardly from the bottom wall 22 and extend between respective front 24 and back walls. Together, the walls define the hollow interior area. Upper ends of the side, front, and back walls define an open top through which the interior area is accessible.

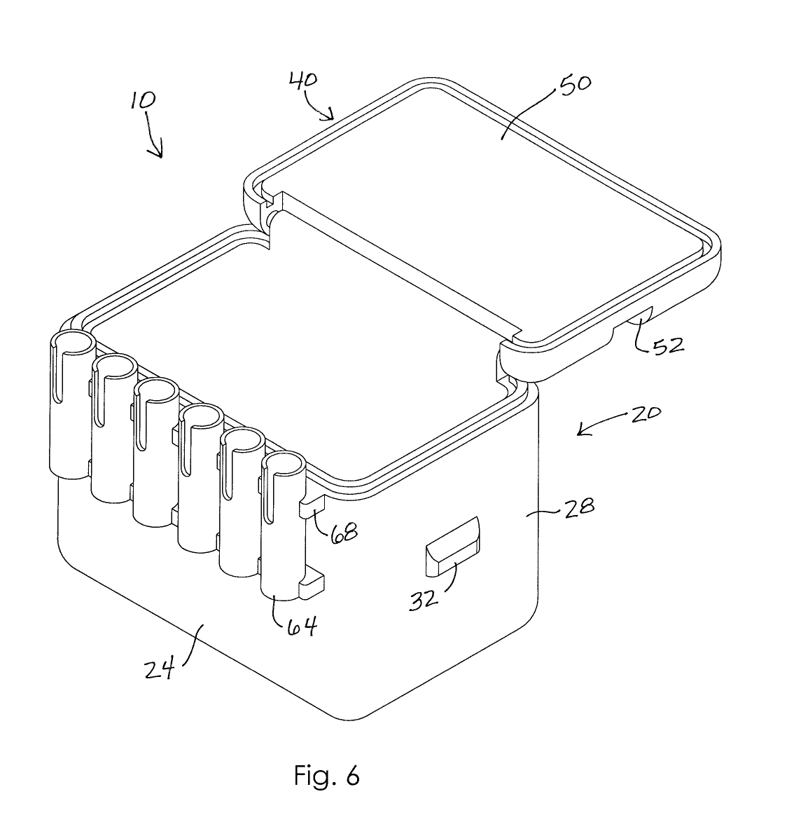

The multi-purpose cooler 10 includes a lid 40 pivotally coupled to an upper edge of the back wall of the container 20, the lid 40 being movable between a closed configuration (FIG. 1) covering the open top 29 of the container 20 and an open configuration (FIG. 6) displaced from the open top 29. Therefore, the interior area is accessible when the lid 40 is in an open configuration and is not accessible when the lid 40 is closed.

Preferably, the wall structure is constructed of an insulated material configured to maintain a temperature within the interior area when the lid 40 is in the closed configuration. The lid 40 includes a top portion 42 and a bottom portion 50. The bottom portion 50 is constructed of an insulated material that helps to maintain a temperature within the interior area when the lid 40 is in the closed configuration.

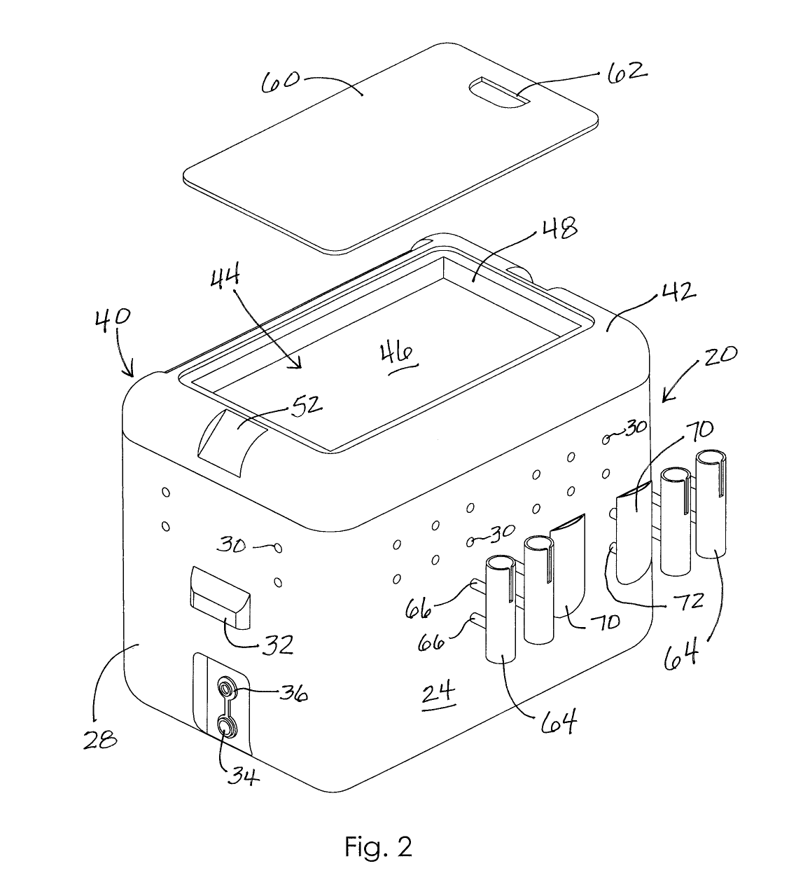

A top surface of the top portion 42 of the lid 40 defines a recessed compartment 44 that extends substantially between opposed ends of the top portion 42 (FIG. 2). Preferably, the recessed compartment 44 also extends substantially between opposed front and back sides of the lid 40 such that the recessed compartment 44 substantially covers the entirety of the top portion 42. The recessed compartment 44 includes a bottom surface 46. The recessed compartment 44 also includes a shelf 48 extending about a peripheral edge of the bottom surface 46, the shelf 48 extending upwardly from the bottom surface 46. The upwardly extending shelf 48 defines an open space suitable to receive and store articles such as fish cutting tools or the like.

A cutting board 60 may be situated atop the shelf 48 and is dimensioned to cover the open space and prevent access thereto when positioned atop the shelf 48. Conversely, the compartment 44 may be accessed when the cutting board 60 is removed from the shelf 48. In one embodiment, the cutting board 60 includes a generally planar configuration and may have a generally rectangular shape. The cutting board 60 defines a handle opening 62 proximal an end thereof configured to enable a user to selectively remove the cutting board 60 from a position atop the shelf 48. The shelf 48 itself is recessed beneath a top surface of the top portion 42, the thickness of the displacement being about the same as a thickness of the cutting board 60. Accordingly, an upper surface of the cutting board 60 is generally flush with the top surface of the top portion 42 of the lid 40 when the cutting board 60 is situated atop the shelf 48.

Preferably, the cutting board 60 is constructed of a durable material that resists becoming scratched such as by cutting utensils that may be used to cut fish or other items on the cutting board 60. By contrast, the bottom portion 50 of the lid 40 may be constructed of an insulated plastic material designed to maintain a temperature within the interior area of the container 20.

In another aspect, the multi-purpose cooler 10 includes a plurality of rod holders 64 each configured to receive a handle of a respective fishing rod (not shown). More particularly, a rod holder 64 includes a bottom wall and a generally cylindrical continuous side wall extending upwardly from the bottom wall. Each rod holder 64, therefore includes a closed bottom and an open top such that a fishing rod is held upright when its handle is inserted into the rod holder 64.

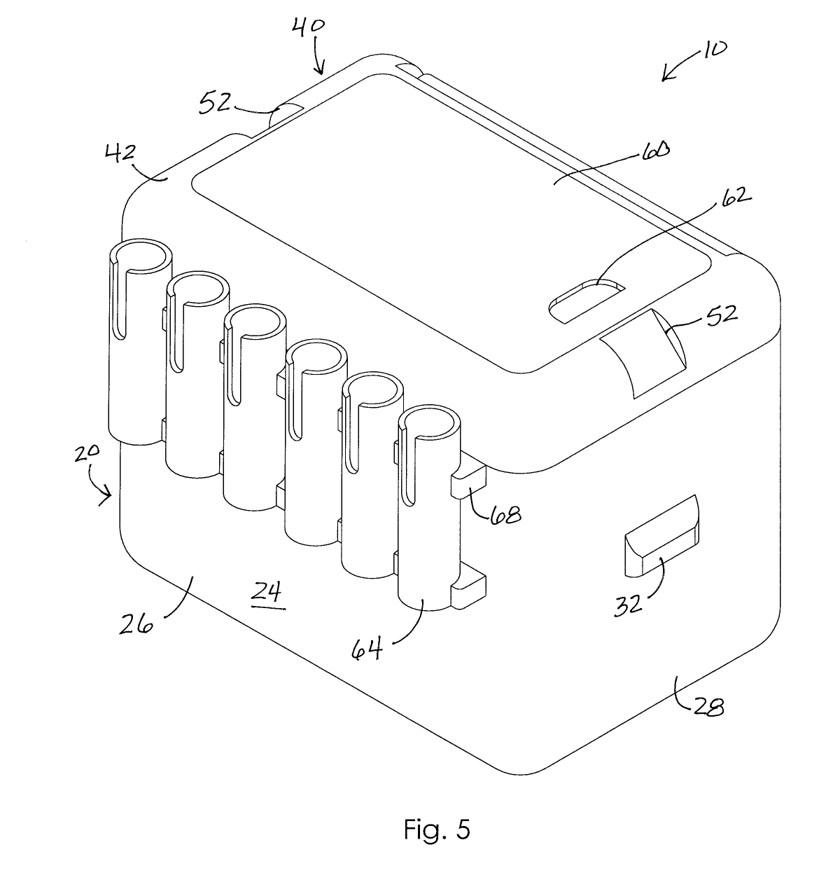

In an embodiment, the exterior surface of the container 20 may define a plurality of spaced apart apertures 30. Correspondingly, each rod holder 64 may include a flange 66 having a configuration that is complementary to a configuration of each aperture 30 so as to be selectively received therein. Accordingly, a rod holder 64 can be coupled to the exterior surface in a friction fit or snap fit engagement (FIG. 2). Similarly, the multi-purpose cooler 10 may include at least one tool holder 70 having a flange 72 for selective coupling to an aperture 30 of the exterior surface of the container 20. The tool holder 70 may include a closed-bottom sleeve defining an open top configured to hold a tool, such as pliers, a knife, or other tools. In another embodiment, the rod holders 64 may be received in brackets 68 that are permanently attached to the exterior surface of the container 20 (FIG. 5).

Referring again to the container 20, opposed side walls 28 may each include a handle 32 configured to enable a user to lift the container 20 in a traditional manner. In addition, ends of the top portion 42 of the lid 40 may define cut-outs 52 or ramped surfaces adjacent the recessed shelf 48 configured to enhance a user's ability to remove the cutting board 60 when resting atop the shelf 48.

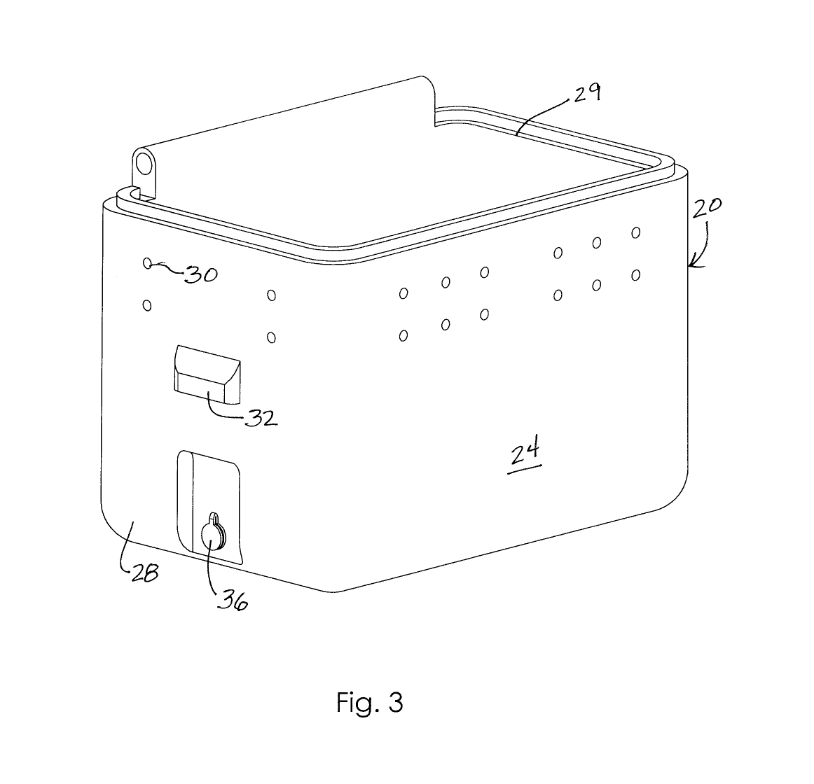

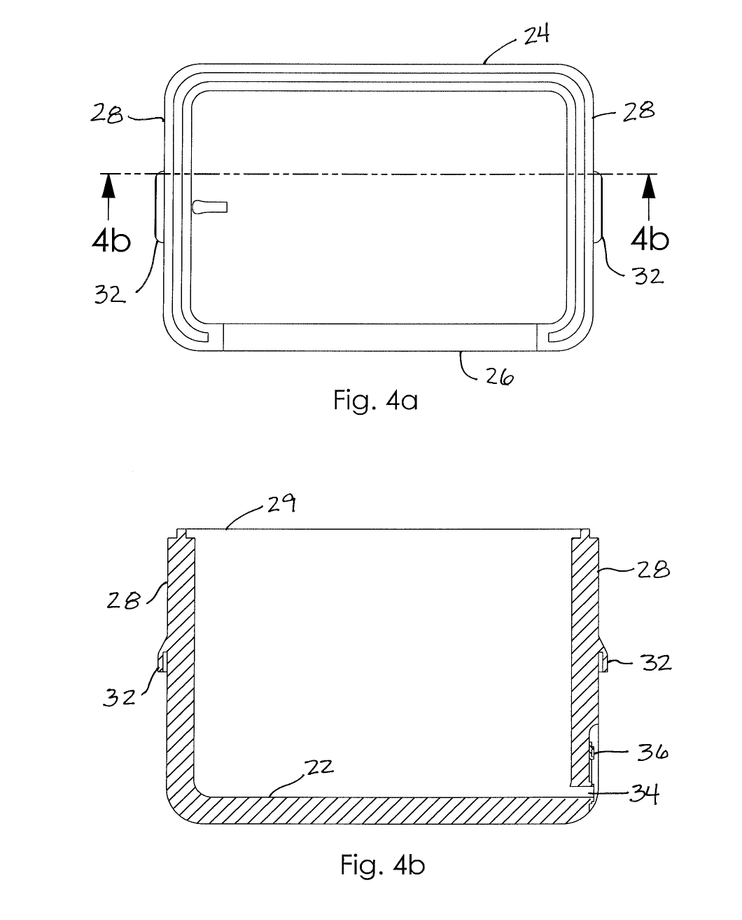

In one embodiment, a side wall 28 of the container 20 may include a drain outlet 34 that communicates the interior area with the outside of the container 20. The drain outlet 34 may include a cap 36 configured to selectively plug the drain outlet 34 (FIGS. 3 and 4b).

In use, the multi-purpose cooler 10 may be used in the manner of a traditional cooler, such as for keeping cold items cold in the insulated interior area of the container 20. In addition, the cutting board 60 may be used as a platform upon which fish or other food items may be cleaned or cut as desired, such as prior to then storing them inside the container 20. Further, tools and other articles may be stored within the recessed compartment 44 when the cutting board 60 is first removed.

It is understood that while certain forms of this invention have been illustrated and described, it is not limited thereto except insofar as such limitations are included in the following claims and allowable functional equivalents thereof.

1. A multi-purpose cooler, comprising:
a substantially hollow container having a wall structure that defines an interior area and an open top that provides access to said interior area;
a lid pivotally mounted to an upper edge of said wall structure and movable between a closed configuration covering said open top and an open configuration displaced from said open top;
wherein said lid includes a top portion and a bottom portion opposite said top portion, said top portion defining a recessed compartment having a bottom surface and a shelf situated about a peripheral edge of said bottom surface and extending upwardly therefrom so as to define an open space; and
a cutting board removably situated atop said shelf, said cutting board being configured to prevent access to said compartment when positioned on said shelf and to allow access to said compartment when removed from said shelf.

2. The multi-purpose cooler as in claim 1, wherein:
said wall structure of said container includes a bottom wall, opposed front and back walls extending upwardly from said bottom wall, and opposed side walls extending upwardly from said bottom wall and extending between respective front and back walls, said bottom, front, back, and side walls defining said interior area and said open top;
said interior area is accessible when said lid is positioned in said open configuration and is not accessible when said lid is positioned in said closed configuration.

3. The multi-purpose cooler as in claim 1, wherein said shelf is recessed below a top surface of said upper portion of said lid such that an upper surface of said cutting board is generally flush with said top surface of said upper portion of said lid when said cutting board is positioned atop said shelf.

4. The multi-purpose cooler as in claim 1, wherein said cutting board has a generally planar configuration and is constructed of a durable material that resists scratches from a cutting implement.

5. The multi-purpose cooler as in claim 4, wherein said bottom portion of said lid is constructed of an insulated plastic material so as to maintain a temperature within said interior area of said container when said lid is in said closed configuration.

6. The multi-purpose cooler as in claim 1, wherein said bottom portion of said lid is constructed of an insulated plastic material so as to maintain a temperature within said interior area of said container when said lid is in said closed configuration.

7. The multi-purpose cooler as in claim 2, wherein:
said bottom wall, said front wall, said back wall, and said side walls are constructed of an insulated plastic material so as to maintain a temperature within said interior area of said container;
said cutting board is constructed of a durable material that resists scratches from a cutting implement.
said bottom portion of said lid is constructed of an insulated plastic material so as to maintain a temperature within said interior area of said container when said lid is in said closed configuration; and

[symbol]

8. The multi-purpose cooler as in claim 1, comprising a plurality of spaced apart rod holders coupled to an exterior surface of said wall structure of said container, each rod holder having a generally cylindrical configuration, a closed bottom, and defining an open top configured to receive a handle of a fishing rod therein.

9. The multi-purpose cooler as in claim 8, wherein:
said exterior surface defines a plurality of spaced apart apertures;
each rod holder includes a flange having a configuration that is complementary to respective apertures such that respective rod holders are selectively coupled to respective apertures of said exterior surface.

10. The multi-purpose cooler as in claim 1, comprising a tool holder coupled to an exterior surface of said wall structure, said tool holder having a sleeve that includes a closed bottom and defines an open top configured to selectively receive a tool therein.

11. The multi-purpose cooler as in claim 9, wherein said at tool holder includes a flange having a configuration that is complementary to respective apertures such that said tool holder is selectively coupled to a respective aperture of said exterior surface.

12. The multi-purpose cooler as in claim 2, wherein each side wall of said wall structure includes a handle configured to enable lifting of said container by a user.

13. The multi-purpose cooler as in claim 1, wherein said cutting board defines a handle opening proximal an end thereof, said handle opening being configured to enable a user to selectively remove said cutting board from a position atop said shelf.

14. The multi-purpose cooler as in claim 2, wherein one said side wall of said container includes a drain outlet configured to communicate said interior area of said container with an area outside said container.

15. The multi-purpose cooler as in claim 1, wherein:
said shelf is recessed below a top surface of said upper portion of said lid such that an upper surface of said cutting board is generally flush with said top surface of said upper portion of said lid when said cutting board is positioned atop said shelf;
said cutting board has a generally planar configuration and is constructed of a durable material that resists scratches from a cutting implement;
said bottom portion of said lid is constructed of an insulated plastic material so as to maintain a temperature within said interior area of said container when said lid is in said closed configuration.

16. The multi-purpose cooler as in claim 15, comprising a plurality of spaced apart rod holders coupled to an exterior surface of said wall structure of said container, each rod holder having a generally cylindrical configuration, a closed bottom, and defining an open top configured to receive a handle of a fishing rod therein.

17. The multi-purpose cooler as in claim 16, wherein:
said exterior surface defines a plurality of spaced apart apertures;
each rod holder includes a flange having a configuration that is complementary to respective apertures such that respective rod holders are selectively coupled to respective apertures of said exterior surface.

18. The multi-purpose cooler as in claim 17, comprising a tool holder coupled to an exterior surface of said wall structure, said tool holder having a sleeve that includes a closed bottom and defines an open top configured to selectively receive a tool therein.
